(19) United States
(12) Patent Application Publication
(10) Pub. No.: US 2004/0154823 A1
(43) Pub. Date: Aug. 12, 2004

(54) Quadruple bonded cable

(76) Inventor: Alan John Amato, Cheshire, CT (US)

Correspondence Address: BLANK ROME LLP, 600 NEW HAMPSHIRE AVENUE, N.W., WASHINGTON, DC, 20037, US

(21) Appl. No.: 10/360,818

(22) Filed: Feb. 10, 2003

(51) Int. Cl. H01B 11/02

(52) U.S. Cl. 174/113 R

(57) ABSTRACT

The present invention is concerned with providing a self-supported hardline communication cable having superior elastic modulus and minimal coefficient of linear expansion. The cable of the present invention has two parts, a coaxial member and a messenger. Both the coaxial member and the messenger are covered with the same jacket. The coaxial member comprises a center conductor covered by a dielectric. Surrounding the dielectric is an outer conductor. The messenger is a metal wire located spaced apart and parallel to the coaxial member. A jacket covers both the coaxial member and the messenger with a web connecting the two parts of the cable together. Bonding occurs between 1) the center conductor and the dielectric; 2) the dielectric and the outer conductor; 3) the outer conductor and the jacket; and 4) the messenger and the jacket. Bonding can be accomplished through heat bonding or an adhesive.

### FIELD OF THE INVENTION

The present invention relates to self-supported hardline communication cable. Particularly, the cable of the present invention has improved elastic modulus and coefficient of linear expansion by way of bonding all the layers of the cable together.

### BACKGROUND OF THE INVENTION

The present invention is concerned with providing a self-supported hardline communication cable having superior elastic modulus and minimal coefficient of linear expansion.

For above ground routes, a self-supported communication cable, for example, cable for transmitting cable television signals, may be suspended from poles so that the cable hangs between each adjacent pair of poles in a catenary. Typically, the cable comprises a strength member (messenger) made of tensile steel which supports the load, and a carried member, which may for example be a more delicate transmission line or lines. The carried member is attached by a common jacket to the strength member. For transmission lines, the typical distance between poles is 125 feet, that is 38 meters. Between the poles, the cable sags due to its own weight, the extent of the sag on installation being determined by the tension in the strength member (messenger), and being designed to be within a range of values determined by the acceptable strength member (messenger) tension and the acceptable extent of eventual sag to avoid hazard. In addition to the suspension load of the weight of the cable itself, an externally-mounted cable is subject to additional variable loading due to wind force and settling of moisture or ice formation. This additional loading results in strain on the cable which will affect all the elements of the cable including the carried line(s).

Messenger wires have widely been used. U.S. Pat. No. 5,777,535 to Farfoud et al. discloses a coaxial member having a messenger wire and a antenna ground wire. Bonding is achieved between the center conductor and the dielectric, and between the dielectric and the outer conductor. There is no bonding between the outer conductor and the jacket, or between the messenger and the jacket.

U.S. Pat. Nos. 3,795,540 and 3,681,515, both to Mildner, disclose shielded cables. In one embodiment, a communication cable with a messenger is disclosed. The communication cable comprises an inner core bundled with a plastic binder tape. The bundle is enclosed in a metal shield. An outer jacket is bonded to the shield. The jacket is also bonded to a messenger wire. No bonding between the plastic binder tape and the metal shield is disclosed. Other embodiments also show only bonding between the metal shield and its adjacent structures. No bonding between the inner core and the plastic binder tape is disclosed. Further, a coaxial member is not disclosed.

U.S. Pat. No. 3,267,201 to Pussey et al. discloses a messenger cable where the messenger is adhesively bonded to the jacket. There is no disclosure of a coaxial member.

U.S. Pat. No. 4,763,983 to Keith discloses a messenger cable where the messenger is adhesively bonded to the jacket. The disclosed cable is an optical transmission cable and is not a coaxial member.

Materials used in the manufacture of hardline communication cables are primarily aluminum and polyethylene (PE). When exposed to a change in temperature, these two materials expand and contract at different rates due to differences in the materials' coefficients of linear expansion. In fact, PE expands/contracts at approximately six times the rate of aluminum. Because of differential expansion/contraction, telecommunication cables have experienced field problems where the cable center conductor pulls out of the connector seize basket resulting in interrupted service downstream. This problem (connector pullout) occurs when the ambient temperature of the installed cable plant is substantially lower or higher than the temperature during the initial cable installation. An acceptable solution to this problem is triple bonding which eliminates differential movement of the materials during thermal expansion/contraction.

A typical self-supported hardline communication cable having a messenger for use in the telecommunication industry is depicted in FIG. 1. The cable comprises a coaxial member and a messenger (2), both which are covered by the same jacket (16). The coaxial member comprises multiple, concentric layers, namely a center conductor (4), dielectric (8), outer conductor (12), and jacket (16). Each of the layers of the coaxial member is bonded to the adjacent layers with a layer of adhesive. The center conductor (4) is bonded to the dielectric (8) by a first adhesive layer (6); the dielectric layer is bonded to the outer conductor by a second adhesive layer (10); and outer conductor (12) is bonded to the jacket (16) by a third adhesive layer (14). A total of three bonding layers are effected in this cable; and the cable is referred to herein as a triple bonded cable.

The triple bonded cable is designed to extend the life of hardline coaxial members and to improve the reliability of its performance. However, a problem occurs when the ambient temperature, to which the installed cable is exposed significantly exceeds the ambient temperature at initial installation. The problem is due to the difference in the coefficient of linear expansion of the coaxial member and the messenger. Typically, this problem is resolved by the addition of expansion loops at regular intervals along the cable plant. The expansion loop is a mechanical cable storage device which stores cable when exposed to temperatures much higher than the ambient temperature during initial installation. In addition, when exposed to temperatures much lower than the ambient temperature at initial installation, the expansion loop supplies cable to the plant. Expansion loops require expensive tools and additional time to form during construction of the hardline coaxial member plant. Furthermore, an improperly formed expansion loop can cause cracks in the cable which requires additional labor to find and repair.

Therefore, there exists the need for an improved communication cable that overcomes the aforementioned disadvantages.

### SUMMARY OF THE INVENTION

An object of the present invention is to provide a self-supported hardline communication cable that overcomes the aforementioned disadvantages. The cable of the present invention has bonding between all layers of the cable, including a bond between the messenger and the jacket. By bonding each layer of the cable with its adjacent layer(s), it is possible to decrease the coefficient of linear expansion at least two fold, and to increase the elastic modulus by at least two fold when compared to a triple bonded cable.

The cable of the present invention has two parts, a coaxial member and a messenger. Both the coaxial member and the messenger are covered with the same jacket. The coaxial member comprises a center conductor covered by a dielectric. Surrounding the dielectric is an outer conductor. The messenger is a metal wire located spaced apart and parallel to the coaxial member. A common jacket covers both the coaxial member and the messenger with a web connecting the two parts of the cable together. Bonding occurs between 1) the center conductor and the dielectric; 2) the dielectric and the outer conductor; 3) the outer conductor and the jacket; and 4) the messenger and the jacket. Bonding can be accomplished through heat bonding or an adhesive.

Methods of making and using the invention are also provided.

### BRIEF DESCRIPTION OF THE DRAWINGS

The foregoing background and summary, as well as the following detailed description of the drawings, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the construction of a triple bonded cable.

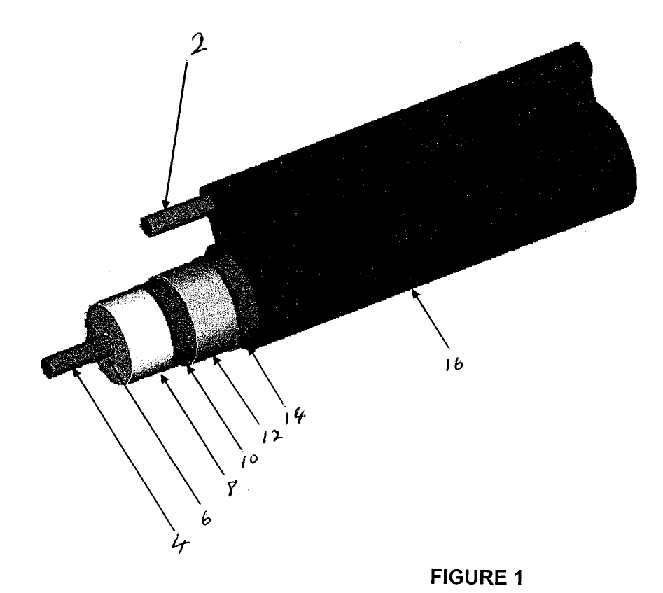

FIG. 2 shows the construction of the present invention.

FIG. 3 compares resultant coefficient of linear expansion between the present invention and the triple bonded cable.

FIG. 4 compares resultant elastic modulus between the present invention and the triple bonded cable.

### DETAILED DESCRIPTION OF THE INVENTION

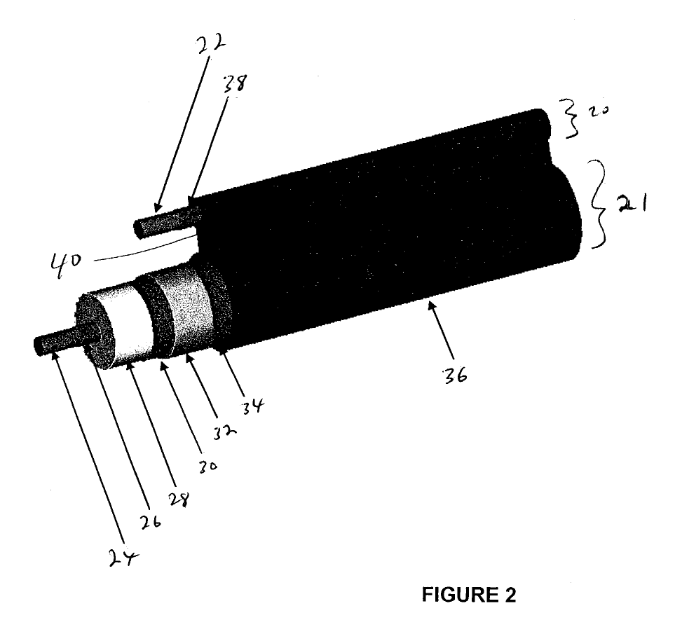

FIG. 2 illustrates the cable of the present invention. The cable of the present invention comprises two parts, a coaxial member (21) and a messenger (20), both covered by the same jacket (36).

The coaxial member comprises several concentric layers. The center conductor (24) is located at the core of the coaxial member. While a copper-clad aluminum conductor is preferred for the center conductor (24), any type of conductive alloy, solid, hollow, stranded, corrugated or clad will suffice.

Covering the center conductor (24) is a dielectric (28). In the preferred embodiment, a low loss gas expanded polyethylene dielectric insulation is bonded to the center conductor (24) using either heat or adhesive technology. However, solid, air, disc and foamed dielectrics can all be used. The important property is that the dielectric material be suitable for manufacturing communication cables.

The dielectric (28) is covered by an outer conductor (32) before a jacket (36) is applied. In a preferred embodiment, the outer conductor (32) is formed from aluminum, copper, or the like. The aluminum or copper can be applied to the dielectric and then bonded thereto.

The jacket (36) can be formed from a variety of non-conductive or semi-conductive compounds typically used to jacket communication cables. Preferably, a black polyethylene (PE) jacket, which provides both ultraviolet protection and good handling characteristics is used. As is known to those skilled in the art, the jacket can also be formed from polyvinyl chloride, TEFLON®, and other compounds. The jacket may also be colored, color coded and/or striped to identify the cable.

The messenger member (20) comprises a steel messenger wire (22) encased in the jacket (36), preferably attached to the coaxial member (21) by a web (40). The web (40) is preferably formed from the same material as the jacket (36). In a preferred embodiment, the jacket that is bonded together between the coaxial and messenger members to form the web (40). The messenger wire (22) may be either solid or stranded. Although different sized wires may be used, it preferably has a diameter between about 0.05″ and about 0.250″.

Preferably the web (40) has a wedge-shaped cross-section. The web (40) is attached to the coaxial member (21) at the web's narrow end. This facilitates peeling the messenger member (20) away from the coaxial member (21), as may be required when forming terminal connections. The web (40), may, instead, have rectangular, square, circular and other cross-sectional shapes.

Importantly, each layer of the coaxial member is bonded to its adjacent layer(s). The center conductor (24) is bonded to the dielectric (28) with an adhesive layer (26); the dielectric (28) is bonded to the outer conductor (32) with an adhesive layer (30); the outer conductor (32) is bonded to the jacket (36) with an adhesive layer (34); and the messenger (22) is bonded to the jacket (36) with an adhesive layer (38). The adhesive layers (26, 30, 34, and 38) can be different or the same. Each adhesive layer is designed to bond different materials; therefore, it is preferable that the adhesive layers is designed to maximize bonding of respective layers of the coaxial member. For example, a thin layer of adhesive formed from an ethylene-acrylic acid (EAA) base can be used to bond the dielectric insulation to the center conductor and to the outer conductor. Preferably, the adhesive is formed from a dielectric material having a dielectric constant similar to that of the dielectric insulation.

In an alternative embodiment, the bonding is accomplished through heat bonding rather than adhesive technology. Heat bonding can be carried out by fusing the dielectric and jacket with their adjacent layer(s). On the other hand, heat bonding can be accomplished with a heat activated adhesive layer, such as a hot-melt adhesive. When heat is applied to the cable, the adhesive layer is activated to bond adjacent layers of the cable together.

The following examples are given to illustrate the present invention. It should be understood that the invention is not limited to the specific conditions or details described in these examples.

### EXAMPLE 1

The resultant coefficient of linear expansion of a cable is calculated using the following equations:

For triple bonded cable:

aᵣ=(A₁E₁a₁+A₂E₂a₂+A₃E₃a₃+A₄E₄a₄)/(A₁E₁+A₂E₂+A₃E₃+A₄E₄)

For the present invention:

aᵣ=(A₁E₁a₁+A₂E₂a₂+A₃E₃a₃+A₄E₄a₄+A₅E₅a₅)/(A₁E₁+A₂E₂+A₃E₃+A₄E₄+A₅E₅)

where

aᵣ is the resultant coefficient of linear expansion,

a₁ is the coefficient of linear expansion of the center conductor,

a₂ is the coefficient of linear expansion of the dielectric,

a₃ is the coefficient of linear expansion of the outer conductor,

a₄ is the coefficient of linear expansion of the jacket,

a₅ is the coefficient of linear expansion of the messenger,

A₁ is the cross sectional area of the center conductor,

A₂ is the cross sectional area of the dielectric,

A₃ is the cross sectional area of the outer conductor,

A₄ is the cross sectional area of the jacket,

A₅ is the cross sectional area of the messenger,

E₁ is the elastic modulus of the center conductor,

E₂ is the elastic modulus of the dielectric,

E₃ is the elastic modulus of the outer conductor,

E₄ is the elastic modulus of the jacket, and

E₅ is the elastic modulus of the messenger.

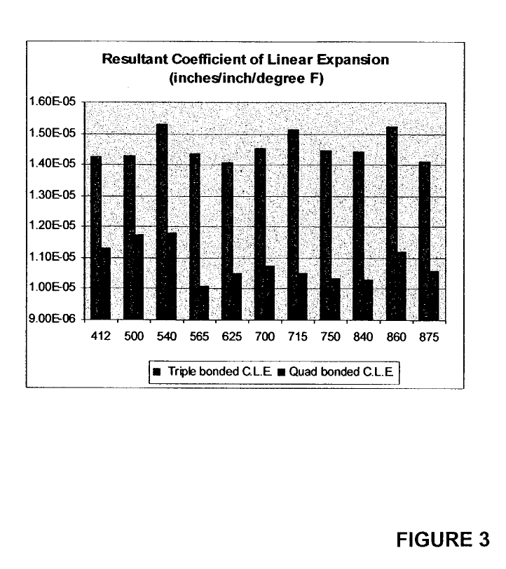

These equations are used to calculate the resultant coefficient of linear expansions for various sized cables (412 Series, 500 Series, 540 Series, 565 Series, 625 Series, 700 Series, 715 Series, 840 Series, 860 Series, and 875 Series). FIG. 3 summarizes the result and compares the resultant coefficient of linear expansion of the present invention and that of the triple bonded cable. The resultant coefficient of linear expansion of the cable of the present invention is less than half that of the triple bonded cable.

### EXAMPLE 2

The resultant elastic modulus of a cable is calculated using the following equations:

For triple bonded cable:

Eᵣ=(A₁E₁+A₂E₂+A₃E₃+A₄E₄)/(A₁+A₂+A₃+A₄)

For the present invention:

Eᵣ=(A₁E₁+A₂E₂+A₃E₃+A₄E₄+A₅E₅)/(A₁+A₂+A₃+A₄+A₅)

where

A₁ is the cross sectional area of the center conductor,

A₂ is the cross sectional area of the dielectric,

A₃ is the cross sectional area of the outer conductor,

A₄ is the cross sectional area of the jacket,

A₅ is the cross sectional area of the messenger,

E₁ is the elastic modulus of the center conductor,

E₂ is the elastic modulus of the dielectric,

E₃ is the elastic modulus of the outer conductor,

E₄ is the elastic modulus of the jacket,

E₅ is the elastic modulus of the messenger, and

Eᵣ is the resultant elastic modulus of the cable.

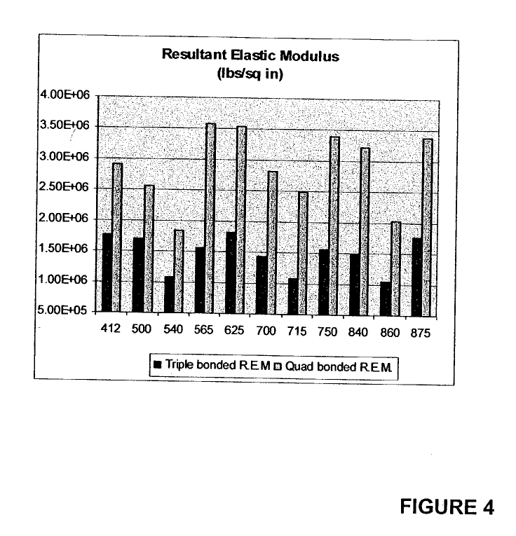

These equations of Example 1 are used to calculate the resultant elastic moduli for various sized cables (412 Series, 500 Series, 540 Series, 565 Series, 625 Series, 700 Series, 715 Series, 840 Series, 860 Series, and 875 Series). FIG. 4 summarizes the result and compares the resultant elastic moduli of the present invention and that of the triple bonded cable. The resultant elastic modulus of the cable of the present invention is at least twice that of the triple bonded cable.

The examples indicate that by bonding all the layers of the cable, problems of the prior art cable can be alleviated.

The invention has been disclosed broadly and illustrated in reference to representative embodiments described above. Those skilled in the art will recognize that various modifications can be made to the present invention without departing from the spirit and scope thereof.

What is claimed is:

1. A cable comprising a coaxial member and a messenger spaced apart and parallel to said coaxial member, both the coaxial member and the messenger are covered by the same jacket;
said coaxial member comprising
a center conductor,
a dielectric surrounding said center conductor,
an outer conductor surrounding said dielectric;
said messenger comprising a wire;
wherein bonding occurs between the center conductor and the dielectric, the dielectric and the outer conductor, the outer conductor and the jacket, and the messenger and the jacket.

2. The cable of claim 1, wherein the center conductor is made of copper clad aluminum, copper, or alloys thereof.

3. The cable of claim 1, wherein the dielectric is made of low loss gas expanded polyethylene.

4. The cable of claim 1, wherein the outer conductor is made of aluminum, copper or alloys thereof.

5. The cable of claim 1, wherein the messenger wire is steel.

6. The cable of claim 1, wherein the jacket is made of polyvinyl chloride or polyethylene.

7. The cable of claim 1, wherein the bonding is selected from the group consisting of heat bonding or an adhesive.

8. The cable of claim 1, wherein the messenger is separated from the coaxial cable by a web in the jacket.

9. The method of making a cable comprising
providing a center conductor;
covering said conductor with a dielectric;
covering said dielectric with an outer conductor;
providing a messenger;
covering said messenger and said conductor with a jacket, wherein said messenger is spaced apart from and parallel to said outer conductor;
bonding the center conductor to the dielectric, the dielectric to the outer conductor, the outer conductor to the jacket, and the messenger to the jacket.

10. The cable of claim 9, wherein the center conductor is made of copper clad aluminum, copper, or alloys thereof.

11. The cable of claim 9, wherein the dielectric is made of low loss gas expanded polyethylene.

12. The cable of claim 9, wherein the outer conductor is made of aluminum, copper or alloys thereof.

13. The cable of claim 9, wherein the messenger wire is steel.

14. The cable of claim 9, wherein the jacket is made of polyvinyl chloride or polyethylene.

15. The cable of claim 9, wherein the bonding is selected from the group consisting of heat bonding or an adhesive.

16. The cable of claim 9, wherein the messenger is separated from the coaxial cable by a web in the jacket.
